(19) United States
(12) Patent Application Publication
(10) Pub. No.: US 2009/0173284 A1
(43) Pub. Date: Jul. 9, 2009

(54) FISH TANK CLEANER

(76) Inventors: Byung Tai YOO, Seoul (KR); Gui Sik YOO, Seoul (KR)

Correspondence Address: KELLY LOWRY & KELLEY, LLP, 6320 CANOGA AVENUE, SUITE 1650, WOODLAND HILLS, CA, 91367, US

(21) Appl. No.: 11/969,431

(22) Filed: Jan. 4, 2008

(51) Int. Cl. A01K 63/04

(52) U.S. Cl. 119/259

(57) ABSTRACT

The present invention relates to a fish tank cleaner having a discharge means for discharging the excrements of fishes together with the water in a fish tank, a filter means for filtering the excrements of fishes in the discharging water, and a returning means for returning the filtered water to the fish tank, the fish tank cleaner including: a discharge port formed below the filter means, for discharging the water staying in a cleaner body to the outside; a viewing window mounted on the top surface of a cover covering the cleaner body, for checking out the interior of the cleaner body; an illuminator mounted on the underside of the cover, for illuminating the interior of the cleaner body; and a sensor mounted on the underside of the cover, for sensing the water not discharged through the filter means.

### BACKGROUND OF THE INVENTION

1. Field of the Invention

The present invention relates to a fish tank cleaner that can clean a fish tank by discharging the excrements of fishes and foreign materials accumulated on the bottom of the fish tank, together with the water in the fish tank and by returning the water from which the excrements of fishes and the foreign materials are removed to the fish tank, thereby preventing the amount of water in the fish tank from being reduced, without any movement of the fishes in the fish tank to the outside, and more particularly, to a fish tank cleaner that can cleanly filter the water in the fish tank by means of a double-filter structure and immediately alarming a user if the water is not discharged well due to the occurrence of the trouble of a water pump or the block of a filter, thereby enabling the discharging problems to be appropriately handled.

2. Background of the Related Art

Generally, fish tanks are installed to watch the activities of fishes or to adjust the indoor humidity appropriately, but the excrements of fishes and the fish food are submerged and decayed on the bottom thereof. On the other hand, algae grow on the inside of the fish tank. So as to keep the fish tank to a clean state, thus, many endeavors should be needed, and above all, it is very cumbersome to maintain a quality of water in the fish tank to a clean state.

The fishes in the fish tank eat their food and produce their excrements, and the excrements are accumulated on the bottom of the fish tank and are decayed to toxic nitrite. Therefore, the water in the fish tank should be periodically exchanged, so as to prevent the mortality of the fishes from occurring. However, it is very cumbersome to periodically perform the exchanging operation of the water in the fish tank, and moreover, whenever the water is exchanged, the fishes should be moved from the fish tank to the outside. So as to maintain a quality of water in the fish tank to a clean state, in the conventional practice, the water in the fish tank is purified by using a water purifier, and after that, the purified water is returned to the fish tank. Otherwise, the excrements of fishes and the foreign materials accumulated on the bottom of the fish tank are discharged together with water. The former has some disadvantages that since the water in the fish tank should be purified without stopping, electrical charge is raised and since the purifying filter should be exchanged timely, the exchanging costs are consumed. On the other hand, the latter does not have any expenses for the electrical charge and the filter exchanging costs, but has some disadvantages that since the water in the fish tank is discharged together with the excrements of fishes, the amount of water is reduced and after cleaning, water should be refilled in the fish tank.

As one prior art, so as to solve these problems, there is proposed Korean Utility Model Registration No. 347619 as filed by the same applicant as in this invention, wherein the excrements of fishes and foreign materials accumulated on the bottom of a fish tank are discharged together with water and filtered by a filter, and after that, the filtered water is filled again in the fish tank, thereby cleaning the fish tank and also preventing the amount of water in the fish tank from being decreased, such that the pollution sources of the water in the fish tank are easily removed to provide good inhabited environments to the fishes in the fish tank.

As another prior art, furthermore, there is proposed Korean Utility Model Registration No. 370594 as filed by the same applicant as in this invention, wherein an opening/closing valve is mounted on a suction pipe from which the water in the fish tank is discharged, such that the water in the fish tank being discharged through the suction pipe can be appropriately adjusted, which allows just the foreign materials in the fish tank to be discharged, and wherein a check valve that is mounted on a discharge pipe from which the water filtered by a filter is returned to the fish tank has a discharge hole adapted to rapidly discharge water remaining in the discharge pipe after finishing a pumping operation.

According to one prior art as mentioned above, the water-filtering process through the filter cannot be checked out at the outside and if the pump has a trouble or the filter is blocked by the foreign materials, water is not effectively returned to the fish tank, which may cause water to be overflowed. On the other hand, according to another prior art, only a single filter is used for filtering the water in the fish tank, which causes the limitation to the clean filtering, and especially, it is inconvenient to exchange and use the filter.

### SUMMARY OF THE INVENTION

Accordingly, the present invention has been made in view of the above-mentioned problems occurring in the prior art, and it is an object of the present invention to provide a fish tank cleaner that can clean a fish tank by discharging the excrements of fishes and foreign materials accumulated on the bottom of the fish tank, together with the water in the fish tank, by filtering the excrements of fishes and the foreign materials by means of filters, and returning the filtered water to the fish tank, such that if the water is not discharged gently through a water pump, the filtered water is discharged to the outside; a filtering process is checked out at the outside through a user's eyes; and an alarm is generated if the water is not discharged gently through the filters.

It is another object of the present invention to provide a fish tank cleaner that cleanly filters the water in a fish tank by means of a double-filter structure and achieves filter exchanging with ease.

To accomplish the above objects, according to the present invention, there is provided a fish tank cleaner wherein the water in a fish tank is supplied into a cleaner body through a suction pipe, is filtered by means of a filter, is pumped by means of a water pump, and is discharged to the fish tank through a discharge pipe, the fish tank cleaner including: first and second filters located above the water pump at the inside of the cleaner body so as to filter the water in the fish tank two times; a discharge port formed at a given position of the cleaner body being higher than the water pump so as to discharge the water staying below the first and second filters in the cleaner body to the outside, while the water filtered through the first and second filters is being discharged to the fish tank through the water pump; a viewing window mounted on the top surface of a cover so as to check out the interior of the cleaner body, the cover being mounted on the top portion of the cleaner body for covering the cleaner body; an illuminator mounted on the underside of the cover so as to illuminate the interior of the cleaner body; a sensor mounted on the underside of the cover so as to sense the water filling into the first and second filters; and an alarm mounted on the top surface of the cover so as to be actuated in response to the sensed result of the sensor, thereby generating an alarming sound if the water is not discharged through the water pump or if the first and second filters are blocked, thereby keeping the water into the cleaner body from being overflowed or keeping the water in the fish tank from staying therein.

Therefore, the fish tank cleaner according to the present invention cleanly filters water in the fish tank two times by means of the first and second filters and achieves filter exchanging with ease.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a fish tank cleaner according to the present invention;

FIG. 2 is a sectional view showing the internal structure of a cleaner body of the fish tank cleaner according to the present invention;

FIG. 3 is an exemplary view showing a cleaning state of the fish tank cleaner according to the present invention;

FIG. 4 is a sectional view showing a check valve of the fish tank cleaner according to the present invention;

FIG. 5 is a plane sectional view showing the check valve of the fish tank cleaner according to the present invention;

FIG. 6 is a sectional view showing the pumping state of the check valve of the fish tank cleaner according to the present invention;

FIG. 7 is a sectional view showing the discharging state of the check valve of the fish tank cleaner according to the present invention;

FIGS. 8 and 9 are exploded perspective views showing first and second filters of the fish tank cleaner according to the present invention;

FIG. 10 is an exploded sectional view showing the first and second filters of the fish tank cleaner according to the present invention;

FIG. 11 is a sectional view showing a cover having a viewing window formed thereon in the fish tank cleaner according to the present invention; and

FIG. 12 is a sectional view showing the cover having a sensor formed thereon in the fish tank cleaner according to the present invention.

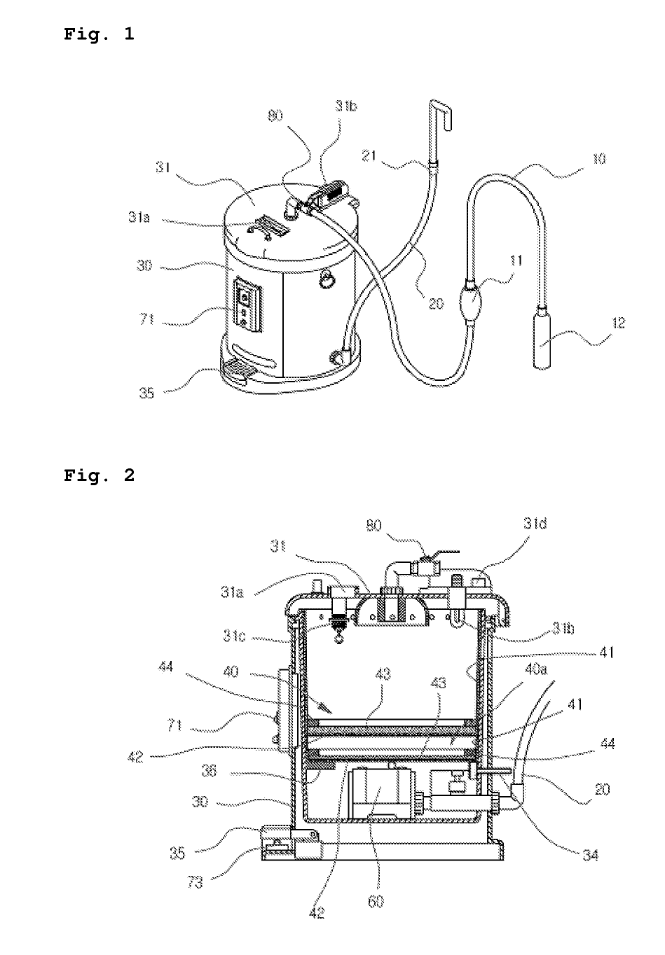

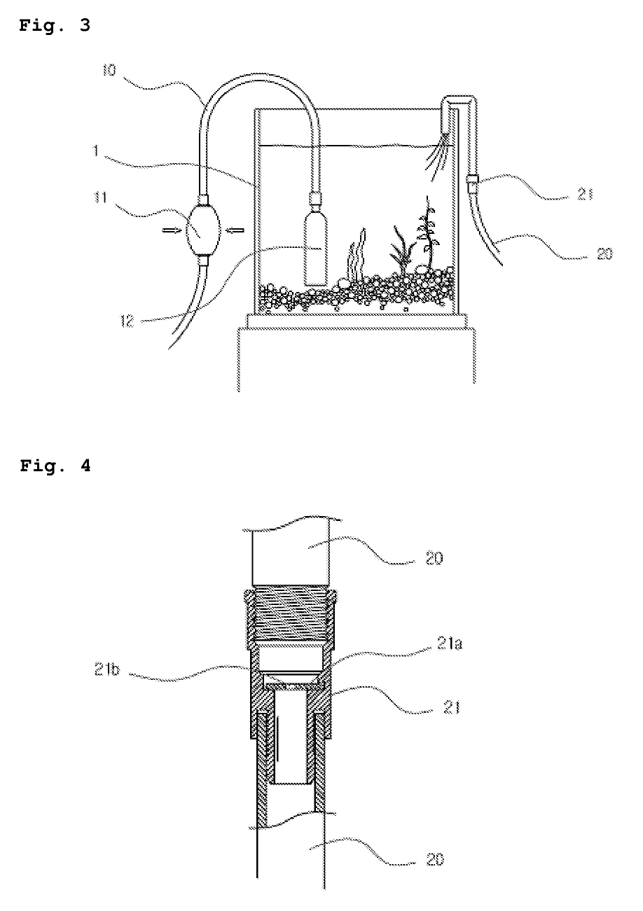

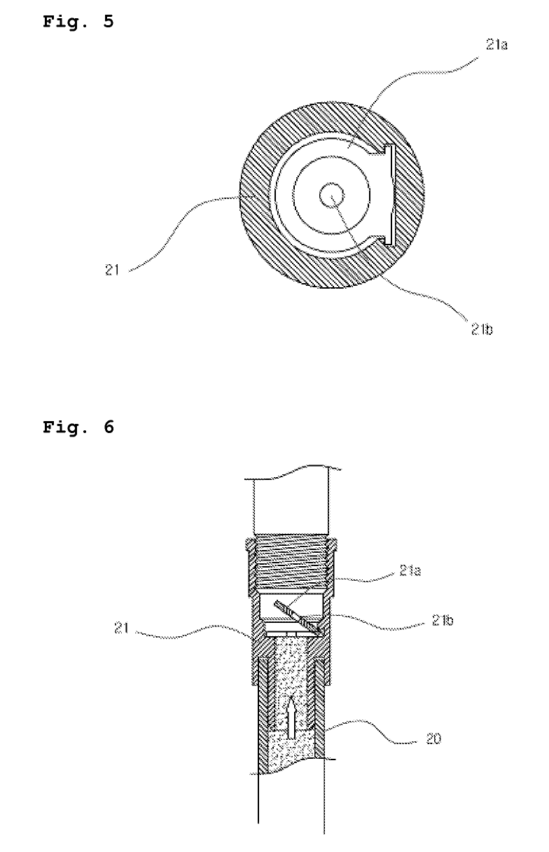

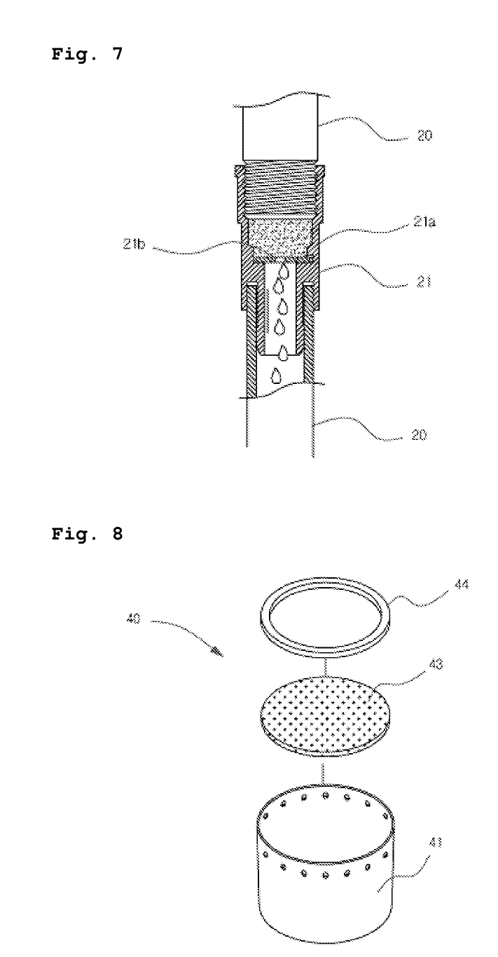

### DETAILED DESCRIPTION OF THE PREFERRED EMBODIMENT

According to the present invention, there is provided a fish tank cleaner that is configured having a cleaner body 30 having a water pump 60 and first and second filters 40 and 40a mounted thereinto, a suction pipe 10, and a discharge pipe 20, such that the water in a fish tank 1 flows into the cleaner body 30 through the suction pipe 10 to pass through the first and second filters 40 and 40a, thereby allowing the excrements of fishes and foreign materials in the water in the fish tank 1 to be filtered together with the water, and the filtered water is pumped by means of the water pump 60 and returned to the fish tank 1 through the discharge pipe 20, wherein a discharge port 34 is formed at a given position of the cleaner body being higher than the water pump 60, such that if the water is not pumped through the water pump 60, the water is discharged through the discharge port 34 to the outside, wherein the first and second filters 40 and 40a are mounted to filter two times the water of the fish tank 1 flowing through the suction pipe 10, such that the water is cleanly filtered and the filter exchanging process is performed with ease, and wherein a viewing window 31a, an illuminator 31b and a sensor 31c are mounted on a cover 31 for covering the cleaner body 30, such that the filtering process through the first and second filters 40 and 40a can be checked out by means of the viewing window 31a with the light emitted from the illuminator 31b and if the water is not smoothly discharged through the first and second filters 40 and 40a, the water filling into the first and second filters 40 and 40a is sensed by means of the sensor 31c, thereby allowing an alarm 31d to be actuated.

Further, an opening/closing valve 80 is mounted between the suction pipe 10 and the cleaner body 30, and a check valve 21 that is mounted on the discharge pipe 20 has a discharge hole 21b formed on a check plate 21a thereof. Instead of the discharge hole 21b, at this time, the check plate 21a may have a space portion 21c formed at one side thereof if the water existing above the check plate 21a can flow down therethrough.

The suction pipe 10 is detachably mounted on the cover 31 adapted to cover the top portion of the cleaner body 30 and has a sucker 11 mounted in the middle portion thereof so as to suck the water in the fish tank 1 and a suction inlet 12 formed at the front end thereof. Thus, the sucker 11 is pressed to cause the water in the fish tank 1 to flow into the suction pipe 10, and the water is discharged to the cleaner body 30. The suction inlet 12 has a larger diameter than the suction pipe 10, such that the excrements of fishes are discharged together with the water and the sand in the water is a little floated in the suction inlet 12, while being not discharged therethrough.

When the water in the fish tank 1 is discharged through the suction pipe 10, if the fish tank 1 is placed at a relatively higher position than the cleaner body 1, the amount of water being discharged through the suction pipe 10 becomes large such that even the sand in the fish tank 1 can be discharged together with the water. So as to prevent the sand in the fish tank 1 from being discharged, thus, the opening/closing valve 80 is mounted to adjust the amount of water being discharged through the suction pipe 10, such that if a height difference between the fish tank 1 and the cleaner body 30 is high, the amount of water being discharged through the suction pipe 10 is reduced by means of the opening/closing valve 80, thereby preventing the sand in the fish tank 1 from being discharged to the cleaner body 30.

Furthermore, the water pump 60 is mounted on the bottom surface inside the cleaner body 30 wherein the suction inlet of the water pump 60 is disposed toward the bottom surface of the cleaner body 30 and the discharge outlet thereof is disposed toward the side surface of the cleaner body 30 in such a manner as to be detachably mounted on the discharge pipe 20. Also, a water level sensor 74 is mounted at the outlet of the water pump 60, and if a water level is sensed by means of the water level sensor 74, the water pump 60 is activated to discharge the water filling into the cleaner body 30 through the discharge pipe 20. At the front surface of the cleaner body 30 are provided a foot plate 35 and a switch 73 having a contact point opened by means of the foot plate 35, such that upon the connection of the switch 73, the water pump 60 is activated to discharge a small quantity of water not sensible by the water level sensor 74.

If the water pump 60 has a trouble, the water filling in the cleaner body 30 is discharged through the discharge port 34 to the outside, and at normal states, the discharge port 34 serves as an external air flowing passageway such that an atmosphere pressure is applied to the water pump 60.

On the other hand, the check valve 21 is mounted on the discharge pipe 20 so as to discharge the water in the cleaner body 30, while preventing the water from flowing reversely, and the discharge pipe 20 has a front end formed lockable at one side of the fish tank 1. Moreover, the discharge hole 21b or the space portion 21c is formed on the check plate 21a of the check valve 21, such that after the operation of the water pump 60 is finished, the water filling into the discharge pipe 20 can be rapidly discharged to the cleaner body 30 by means of the discharge hole 21b or the space portion 21c.

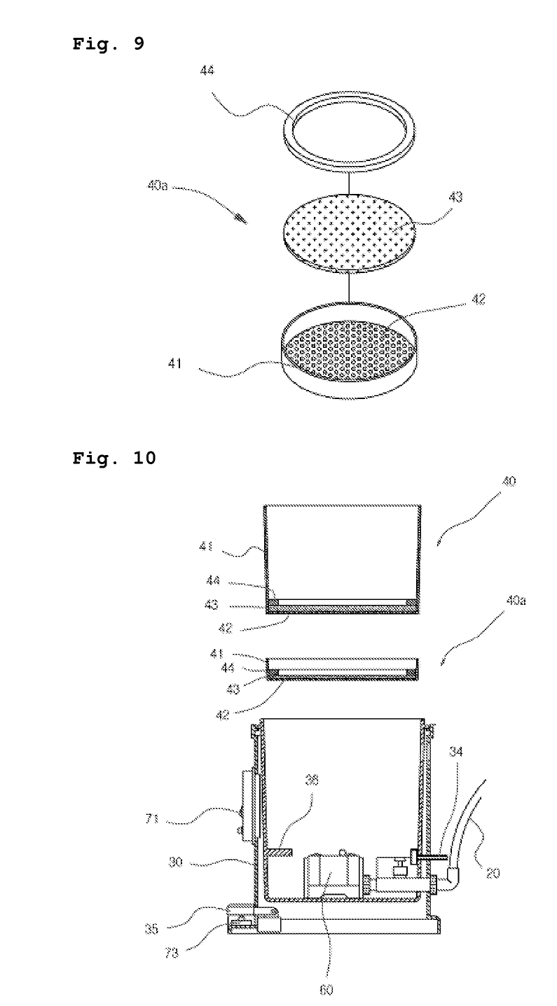

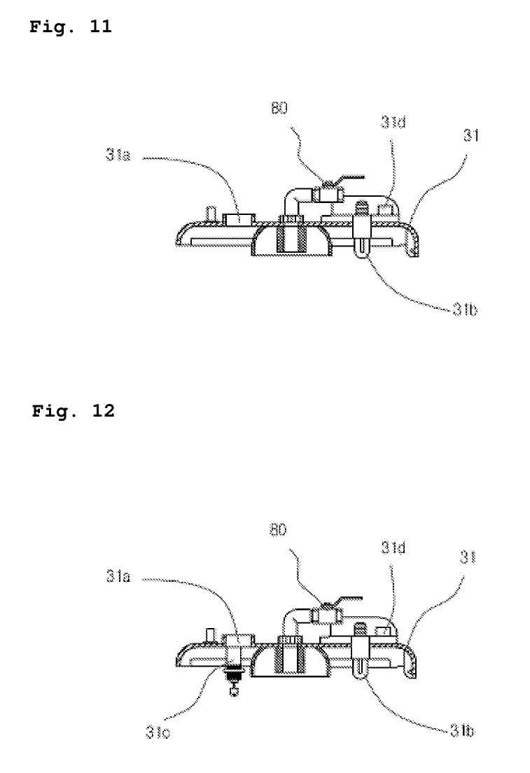

Each of the first and second filters 40 and 40a includes, as shown in FIGS. 8 and 9, a filter case 41 having a plurality of discharge holes 42 formed on the bottom surface thereof, a filtering screen 43 like a non-woven fabric mounted on the bottom portion at the inside of the filter case 41, and a contacting band 44 adapted to allow the top outer periphery of the filtering screen 43 to come into close contact with the filter case 41. At this time, if the filtering screen 43 is to be exchanged with new one, the new filtering screen 43 is mounted after the closing band 44 is removed, and next, the closing band 44 is fitted again along the new filtering screen 43, thereby simply exchanging the filtering screen 43.

The first and second filters 40 and 40a are formed in a double structure, and the second filter 40a is mounted supportedly on the top portion of a support member 36 fixed along the inner periphery of the cleaner body 30, and the first filter 40 is stackingly mounted above the second filter 40a, such that the water in the fish tank 1 is cleanly filtered by the double structure consisting of the first and second filters 40 and 40a and is then returned to the fish tank 1 through the water pump 60.

The cover 31 of the cleaner body 30 of the fish tank cleaner according to the present invention has the viewing window 31a adapted to check out the interior of the cleaner body 30, the illuminator 31b adapted to illuminate the interior of the cleaner body 30, and the sensor 31c adapted to sense the water filling into the first and second filters 40 and 40a, and if the water filling into the first and second filters 40 and 40a is sensed by means of the sensor 31c, the alarm 31d is actuated.

That is, the water filtering process through the first and second filters 40 and 40a is checked out through the viewing window 31a by using the light emitted from the illuminator 31b, and if the water filtering is not performed well through the first and second filters 40 and 40a to cause the water to fill into the cleaner body 30, the water filling is sensed by means of the sensor 31c to allow the alarm 31d to be actuated, thereby alarming a user this.

Under the above-mentioned construction, an explanation on the process of removing the excrements of fishes and the foreign materials accumulated on the bottom of the fish tank 1 and on the process of returning the filtered water to the fish tank 1 will be in detail given below.

First, a power switch 71 is turned on to operate the water pump 60, and next, the front end of the discharge pipe 20 is locked at one side of the fish tank 1. After that, the suction inlet 12 of the suction pipe 10 is disposed under the water, and in this state, if the sucker 11 is repeatedly compressed and released, the water in the fish tank 1 is sucked through the sucker 11 and flows into the first filter 40 via the opening/closing valve 80.

At this time, the sucker 11 has a check valve mounted at both sides thereof. Thus, if compressed, the water therein is discharged to the cleaner body 30, and if released from its compressed state, the water from the suction inlet 12 is sucked filled therein.

The water sucked from the suction inlet 12 flows into the first filter 40, and the excrements of fishes and the foreign materials contained in the water are filtered by means of the filtering screen 43. Next, the filtered water is supplied to the second filter 40a and is filtered again there, such that the water passed through the first and second filters 40 and 40a becomes completely clean.

When the water flows through the suction pipe 10, the water in the fish tank 1 continuously flows into the first and second filters 40 and 40a by the principle of siphon, even though the sucker 11 is not compressed. At this state, the suction inlet 12 is moved within the fish tank 1 to cause the excrements of fishes and the foreign materials to be sucked together with the sucked water, and the sand in the fish tank 1 is floated in the lower portion of the suction inlet 12. However, since the specific gravity of the sand is a little heavy, the sand is not floated up to the suction pipe 10, such that the sand is not almost discharged and the excrements of fishes and foreign materials having relatively light specific gravity are discharged through the suction pipe 10.

However, if the fish tank 1 is placed at a higher position than the cleaner body 30, the suction force of the suction pipe 10 is strong such that sand is even sucked to the suction pipe 10 together with water. In this case, the opening/closing valve 80 is adjusted to its opening/closing degree to reduce the amount of water being discharged through the suction pipe 10, which prevents the sand from being discharged from the suction pipe 10.

That is, if the height difference between the fish tank 1 and the cleaner body 30 is not high, the operation of the suction pipe 10 starts at the state where the opening/closing valve 80 is opened, but contrarily, if the height difference therebetween is high, the operation of the suction pipe 10 starts at the state where the opening/closing valve 80 is a little closed, such that the amount of water being discharged from the suction pipe 10 is gradually reduced to allow the excrements of fishes and foreign materials to be discharged together with the water, without any suction of the sand in the fish tank 1.

The water discharged from the suction pipe 10 is filtered through the first and second filters 40 and 40a, and the filtered water is filled into the cleaner body 30 having the water pump 60 mounted therein. If the water filling into the cleaner body 30 is sensed by means of the water level sensor 74, the water pump 60 is operated to permit the water to be returned to the fish tank 1 through the discharge pipe 20, and if the water level is not sensed, the operation of the water pump 60 stops.

In other words, if the water is filled by a given amount into the cleaner body 30, the water pump 60 is operated to pump the water up to the fish tank 1, and if the level of water becomes lowered, the operation of the water pump 60 stops, such that a small amount of water always stays into the cleaner body 30.

The discharge valve 20 has the check valve 21 mounted thereon, and thus, if water discharging stops during the discharge operation, the water remaining into the discharge pipe 20 does not flow back to the cleaner body 30, thereby enabling the water pump 60 to be gently operated.

At this time, the check plate 21a is mounted into the check valve 21, which prevents the water filling into the discharge pipe 20 from being easily discharged to the cleaner body 30, and after the pumping operation is finished, if the discharge pipe 20 is removed from the fish tank 1, the formation of the check valve 21 keeps the water filling into the discharge pipe 20 from being discharged easily to the cleaner body 30. So as to discharge the water from the discharge pipe 20, thus, the discharge pipe 20 has to be swung for a while, which makes it inconvenient to use, and to avoid this problem, according to the present invention, the discharge hole 21b or the space portion 21c having a relatively small diameter is formed on the check plate 21a of the check valve 21, such that upon a normal pumping operation, the pumping stops for a short period of time during which the water fills into the cleaner body 30 at the state where the water fills on the check plate 21a. In this case, however, the water filling on the check plate 21a is pumped again before discharged through the discharge hole 21b or the space portion 21c, which does not matter. If the water pump 60 is not operated for a while after the pumping operation is completely finished, however, the water filling on the check plate 21a is discharged through the discharge hole 21b or the space portion 21c, and at this instant, the water is rapidly discharged therethrough, such that no separate operation of discharging the water filling into the discharge pipe 20 is needed upon the removal of the discharge pipe 20 from the fish tank 1, which makes it convenient to use.

That is, while the fish tank 1 is being normally cleaned, the check valve 21 is normally operated, and if the pumping stops after the completion of the cleaning, the water filling on the check plate 21a is discharged through the discharge hole 21b or the space portion 21c, and at this instant, the surface of the water filling on the check plate 21a is completely lowered, such that the discharge pipe 20 is raised up by the user for a moment after the completion of the pumping, the water remaining into the discharge pipe 20 is easily discharged therefrom.

On the other hand, even when the water pump 60 mounted into the cleaner body 30 stops or has a trouble, if the water filtered through the first and second filters 40 and 40a is kept flow down, the water can be discharged through the discharge port 34 to the outside.

Further, the filtering process of the water through the first filter 40 can be checked out by using the viewing window 31a mounted on the cover 31, at the state where the interior of the cleaner body 30 is illuminated by means of the illuminator 31b.

Additionally, if the water is not gently filtered through the first and second filters 40 and 40a, the water fills into the first filter 40, and at this time, the filling water is sensed by means of the sensor 31c, thereby permitting the alarm 31d to be actuated to take an immediate action thereto.

Especially, the fish tank cleaner of the present invention makes the use of the first and second filters 40 and 40a having the filtering screen 43 easily exchangeable, such that it is easy to filter water to a clean state.

As mentioned above, there is provided a fish tank cleaner according to the present invention that can clean a fish tank by discharging the excrements of fishes and foreign materials, together with the water in the fish tank, by filtering the excrements of fishes and the foreign materials by means of filters, and returning the filtered water to the fish tank, thereby preventing the amount of water in the fish tank from being reduced, and that there is no need to move the fishes in the fish tank to the outside during cleaning, thereby reducing the stresses applied to the fishes, and since the water is not almost discharged to the outside, there is no need to supply water to the fish tank anymore, and that if a water pump has a trouble, water is allowed to be discharged to the outside and if water is not discharged through the filters, an alarm is actuated.

In addition, the fish tank cleaner of the present invention enables a water-filtering process to be checked out by a user's eyes, permits the water in the fish tank to be cleanly filtered by means of a double-filter structure, and achieves filter exchanging with ease.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A fish tank cleaner wherein the water in a fish tank is supplied into a cleaner body through a suction pipe, is filtered by means of a filter, is pumped by means of a water pump, and is discharged to the fish tank through a discharge pipe, the fish tank cleaner comprising:
first and second filters located above the water pump at the inside of the cleaner body so as to filter the water in the fish tank two times;
a discharge port formed at a given position of the cleaner body being higher than the water pump so as to discharge the water staying below the first and second filters in the cleaner body to the outside, while the water filtered through the first and second filters is being discharged to the fish tank through the water pump;
a viewing window mounted on the top surface of a cover so as to check out the interior of the cleaner body, the cover being mounted on the top portion of the cleaner body for covering the cleaner body;
an illuminator mounted on the underside of the cover so as to illuminate the interior of the cleaner body;
a sensor mounted on the underside of the cover so as to sense the water filling into the first and second filters; and
an alarm mounted on the top surface of the cover so as to be actuated in response to the sensed result of the sensor.

2. The fish tank cleaner according to claim 1, wherein the second filter is mounted supportedly on the top portion of a support member fixed along the inner periphery of the cleaner body above the water pump, and the first filter is mounted stackingly above the second filter.

3. The fish tank cleaner according to claim 1, wherein each of the first and second filters comprises a filter case having a plurality of discharge holes formed on the bottom surface thereof, a filtering screen mounted on the bottom portion at the inside of the filter case so as to filter foreign materials in the water, and a contacting band adapted to allow the top outer periphery of the filtering screen to come into close contact with the filter case.

4. The fish tank cleaner according to claim 2, wherein each of the first and second filters comprises a filter case having a plurality of discharge holes formed on the bottom surface thereof, a filtering screen mounted on the bottom portion at the inside of the filter case so as to filter foreign materials in the water, and a contacting band adapted to allow the top outer periphery of the filtering screen to come into close contact with the filter case.
